(19) United States
(12) Patent Application Publication
(10) Pub. No.: US 2026/0285400 A1
(43) Pub. Date: Sep. 24, 2026

(54) CONTROL DEVICE FOR ARTICULATED VEHICLE, CONTROL METHOD FOR ARTICULATED VEHICLE, AND NON-TRANSITORY COMPUTER-READABLE MEDIUM

(71) Applicants: JTEKT CORPORATION, Kariya-shi, Aichi-ken (JP); J-QuAD DYNAMICS INC., Tokyo (JP)

(72) Inventors: Hirotaka TOKORO, Tokyo (JP); Nobuhiro NITTA, Tokyo (JP); Terutaka TAMAIZUMI, Okazaki-shi (JP); Hiromasa TAMAKI, Okazaki-shi (JP)

(73) Assignees: JTEKT CORPORATION, Kariya-shi, Aichi-ken (JP); J-QuAD DYNAMICS INC., Tokyo (JP)

(21) Appl. No.: 18/997,989

(22) PCT Filed: Jul. 25, 2023
(86) PCT No.: PCT/JP2023/027282

§ 371 Date: Jan. 23, 2025

(30) Foreign Application Priority Data
Aug. 22, 2022 (JP) 2022-131793

(51) Int. Cl. B62D 13/06

(52) U.S. Cl. CPC B62D 13/06

(57) ABSTRACT

An articulated vehicle includes a tractor and a trailer. The tractor includes an input unit and steered wheels. A control device executes switching determination processing, tractor steering processing, and trailer steering processing. The switching determination processing is processing of determining whether a reverse assist mode is in an on state or an off state. The tractor steering processing is processing of steering the tractor in response to an input operation to the input unit in a case in which the reverse assist mode is in the off state. The trailer steering processing is processing of operating the steered angle of the steered wheels in order to steer the trailer in response to an input operation to the input unit in a case in which the reverse assist mode is in the on state, in a state in which power transmission between the input unit and the steered wheels is interrupted.

### TECHNICAL FIELD

The present disclosure relates to a control device for an articulated vehicle, a control method for the articulated vehicle, and a control program for the articulated vehicle.

### BACKGROUND ART

Conventionally, there is an articulated vehicle that is made up of a trailer linked to a tractor. Patent Document 1 proposes a control device that assists in reverse driving of the articulated vehicle. This control device operates steered wheels to control traveling of the trailer in response to a driver operating a knob.

### RELATED ART DOCUMENTS

### Patent Documents

Patent Document 1: U.S. Pat. No. 10,144,452

### SUMMARY OF THE INVENTION

### Problem to be Solved by the Invention

In the above case, means for inputting intent of the driver to steer the trailer is required separately from means for inputting intent to steer the tractor.

### Means for Solving the Problem

One aspect of the present disclosure provides a control device of an articulated vehicle including a tractor and a trailer that is towed by the tractor. The tractor includes an input unit and steered wheels. The control device is configured to execute switching determination processing, tractor steering processing, and trailer steering processing. The switching determination processing is processing of determining whether a reverse assist mode is in an on state or an off state. The tractor steering processing is processing of steering the tractor in response to an input operation to the input unit in a case in which the reverse assist mode is in the off state. The trailer steering processing is processing of operating a steered angle of the steered wheels in order to steer the trailer in response to an input operation to the input unit in a case in which the reverse assist mode is in the on state, in a state in which power transmission between the input unit and the steered wheels is interrupted.

Another aspect of the present disclosure provides a control method for an articulated vehicle including a tractor and a trailer that is towed by the tractor. The tractor includes an input unit and steered wheels. The control method includes a step of executing switching determination processing, tractor steering processing, and trailer steering processing. The switching determination processing is processing of determining whether a reverse assist mode is in an on state or an off state. The tractor steering processing is processing of steering the tractor in response to an input operation to the input unit in a case in which the reverse assist mode is in the off state. The trailer steering processing is processing of operating a steered angle of the steered wheels in order to steer the trailer in response to an input operation to the input unit in a case in which the reverse assist mode is in the on state, in a state in which power transmission between the input unit and the steered wheels is interrupted.

An aspect of the present disclosure provides a control program for an articulated vehicle including a tractor and a trailer that is towed by the tractor. The tractor includes an input unit and steered wheels. The control program is configured to cause a computer to execute switching determination processing, tractor steering processing, and trailer steering processing. The switching determination processing is processing of determining whether a reverse assist mode is in an on state or an off state. The tractor steering processing is processing of steering the tractor in response to an input operation to the input unit in a case in which the reverse assist mode is in the off state. The trailer steering processing is processing of operating a steered angle of the steered wheels in order to steer the trailer in response to an input operation to the input unit in a case in which the reverse assist mode is in the on state, in a state in which power transmission between the input unit and the steered wheels is interrupted.

### BRIEF DESCRIPTION OF THE DRAWINGS

FIG. 1 is a perspective view illustrating a configuration of an articulated vehicle according to an embodiment.

FIG. 2 is a block diagram illustrating a configuration of a control system that the articulated vehicle illustrated in FIG. 1 is equipped with.

FIG. 3 is a flowchart showing procedures of processing that is executed by a control device illustrated in FIG. 2.

FIG. 4 is a diagram illustrating a model of the articulated vehicle illustrated in FIG. 1.

FIG. 5 is a flowchart showing procedures of processing that is executed by the control device according to the embodiment illustrated in FIG. 2.

FIG. 6 is a flowchart showing procedures of processing that is executed by the control device according to the embodiment illustrated in FIG. 2.

FIG. 7 is a flowchart showing procedures of processing that is executed by the control device according to the embodiment illustrated in FIG. 2.

FIG. 8A to FIG. 8C are diagrams illustrating operations relating to the embodiment.

FIG. 9A to FIG. 9D are diagrams illustrating operations relating to the embodiment.

### MODES FOR CARRYING OUT THE INVENTION

An embodiment will be described below with reference to the drawings.

### “Configuration of Articulated Vehicle”

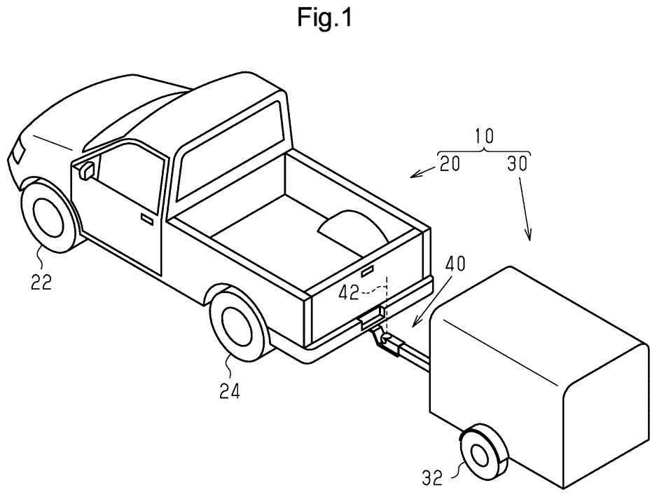

As illustrated in FIG. 1, an articulated vehicle 10 includes a tractor 20 and a trailer 30. The tractor 20 includes front wheels 22 and rear wheels 24. The front wheels 22 include two wheels, which are a right front wheel and a left front wheel, and the rear wheels 24 include two wheels, which are a right rear wheel and a left rear wheel. Also, FIG. 1 exemplifies an enclosed box trailer as the trailer 30. The trailer 30 has wheels 32. The wheels 32 include two wheels, which are a right wheel and a left wheel.

The trailer 30 is linked to a rear portion of the tractor 20 via a ball joint 40. The ball joint 40 is a member that links the trailer 30 to the tractor 20 such that the trailer 30 can rotate about an axis 42. The axis 42 extends in a height direction of the tractor 20.

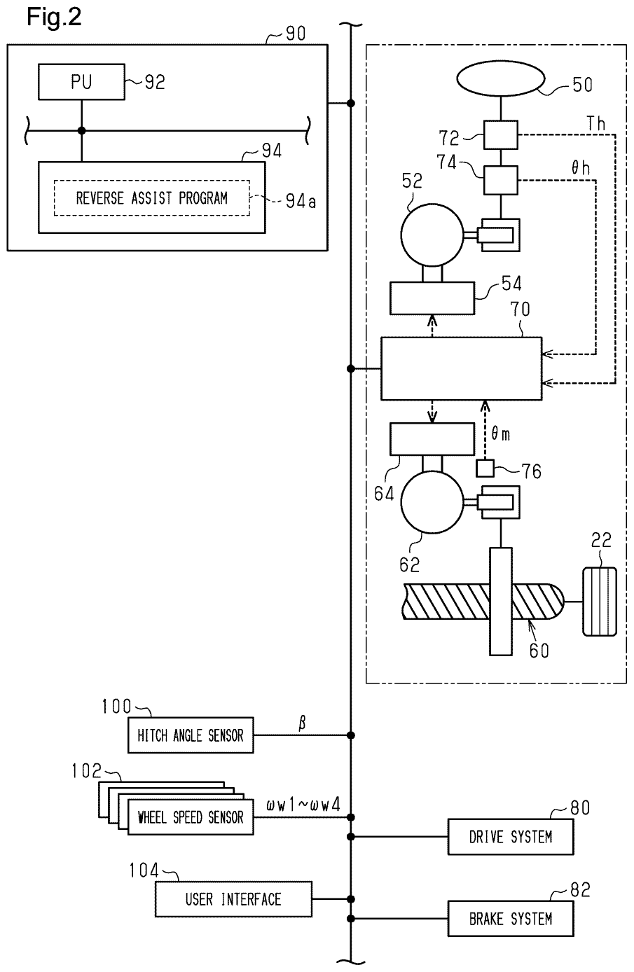

FIG. 2 illustrates part of members that the tractor 20 is equipped with. As illustrated in FIG. 2, a reactive force is applied to a steering wheel 50 in a steering system that is provided in the tractor 20 by a reactive force motor 52. Reactive force is torque of an opposite sign to torque that is applied to the steering wheel 50 by a driver. Output voltage of an inverter 54 is applied to a terminal of the reactive force motor 52.

On the other hand, power of a steering motor 62 is applied to the front wheels 22 that serve as steered wheels provided to the steering system, via a rack and pinion mechanism 60. Output voltage of an inverter 64 is applied to a terminal of the steering motor 62.

A steering control device 70 controls the torque of the reactive force motor 52, in order to control a controlled variable of the steering wheel 50, which is an object to be controlled. The controlled variable here is the reactive force. Also, the steering control device 70 controls torque of the steering motor 62 in order to control the controlled variable of the front wheels 22 that is the object of control. The controlled variable here is a steered angle. The steered angle is a turning angle of the tires of the front wheels 22.

The steering control device 70 references steering torque Th that is torque input to the steering wheel 50 and that is detected by a torque sensor 72, in order to control the controlled variable. Also, the steering control device 70 references a steering angle θh that is detected by a steering angle sensor 74 in order to control the controlled variable. Also, the steering control device 70 references to a rotational angle θm of the steering motor 62 that is detected by the rotation angle sensor 76 in order to control the controlled variable.

The tractor 20 is equipped with a drive system 80. The drive system 80 includes at least one of two devices which are an internal combustion engine and a rotating electrical machine, as a thrust generating device for the vehicle. The tractor 20 is equipped with a brake system 82. The brake system 82 includes at least one of two devices which are a device that reduces the speed of rotation of the wheels by frictional force, and a device that reduces the speed of rotation of the wheels by converting power of the wheels into electrical energy. Note that the device, which reduces the speed of rotation of the wheels by conversion into electrical energy, may be shared with the rotating electrical machine of the drive system.

The tractor 20 is equipped with an ADAS ECU 90. The ADAS ECU 90 operates the steering system, the drive system 80, and the brake system 82 in order to control the controlled variables of the articulated vehicle 10 that is the object of control. The controlled variables are vehicle speed, direction of travel, hitch angle, and so forth. The hitch angle is an angle formed between a front-rear direction of the tractor 20 and a front-rear direction of the trailer 30. Note that the drive system 80 may include a drive control device regarding which the internal combustion engine and the rotating electrical machine are objects of control. In this case, “the ADAS ECU 90 operates the drive system 80” means that the ADAS ECU 90 outputs a command signal to the drive control device. Also, the brake system 82 may include a brake control device of which the devices that reduce the speed of rotation of the wheels are objects of control. In this case, “the ADAS ECU 90 operates the brake system 82” means that the ADAS ECU 90 outputs a command signal to the brake control device. Also, “the ADAS ECU 90 operates the steering control device 70” means that the ADAS ECU 90 outputs a command signal to the steering control device 70.

The ADAS ECU 90 references a hitch angle β that is detected by a hitch angle sensor 100 in order to control the controlled variable. The hitch angle β may take either a positive sign or a negative sign in accordance with an angle formed between a direction of travel of the tractor 20 from rear to front and a direction of travel of the trailer 30 from rear to front. For example, the hitch angle β may take a positive sign in a case in which the direction of travel of the trailer 30 from rear to front deviates counterclockwise from the direction of travel of the tractor 20 from rear to front by less than 180°. The ADAS ECU 90 also references wheel speeds ωw1 to ωw4 that are detected by wheel speed sensors 102. The wheel speeds ωw1 and ωw2 are the rotational speed of the right front wheel 22 and the rotational speed of the left front wheel 22, respectively. The wheel speeds ωw3 and ωw4 are the rotational speed of the right rear wheel 24 and the rotational speed of the left rear wheel 24, respectively.

The ADAS ECU 90 sets the control of the controlled variable in response to a state of operation of a user interface 104. The user interface 104 is used to transmit intent of a user to the ADAS ECU 90, such as an intent to select one of the two of automated driving and manual driving, or the like.

The ADAS ECU 90 includes a PU 92 and a storage device 94. The PU 92 is a software processing device including at least one of a CPU, a GPU, a TPU, and so forth. The storage device 94 stores a reverse assist program 94a. The reverse assist program 94a is a program that defines commands to cause the PU 92 to execute reverse assist processing. The reverse assist processing is processing of automatically performing steering processing of the steered wheels when the articulated vehicle 10 is traveling in reverse. The reverse assist program 94a is a program for reducing a burden on the driver due to reverse driving.

That is to say, when the articulated vehicle 10 is traveling in reverse, even when the steered angle of the tractor 20 is the same, behavior of the trailer 30 will change in accordance with the hitch angle β. Accordingly, reverse control requires advanced driving skills. The reverse assist processing by the reverse assist program 94a is processing of assisting the driver by controlling the steered angle of the tractor 20. Note however, that in the reverse assist processing, instructions to steer the trailer 30 are entrusted to the driver. Here, the steering of the trailer 30 is instructed by the steering wheel 50. That is to say, when a reverse assist mode in which the reverse assist processing is executed is in an on state, the steering wheel 50 serves as means for inputting instructions regarding steering of the trailer 30. On the other hand, in a case in which the reverse assist mode is in an off state, the steering wheel 50 serves as means for inputting instructions regarding steering of the tractor 20.

### “Transitioning to Reverse Assist Mode”

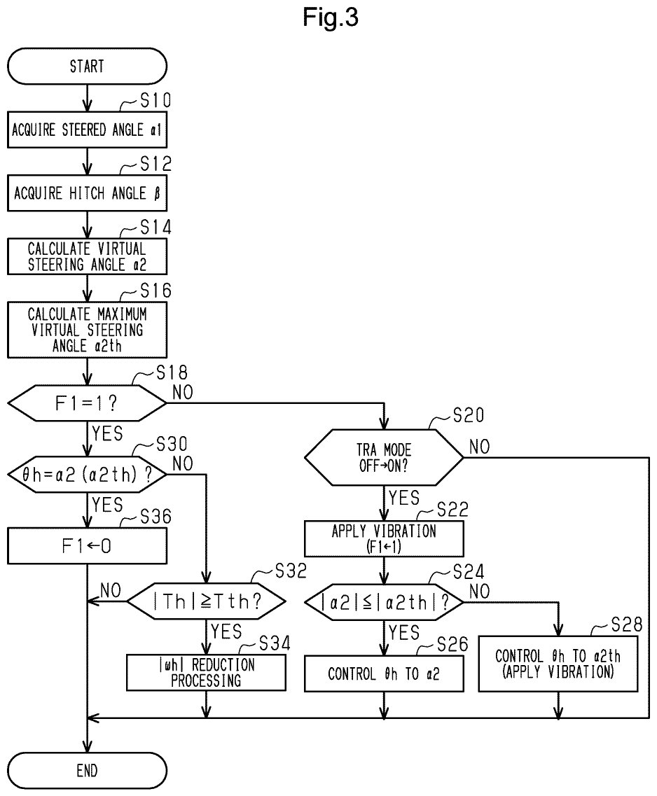

FIG. 3 shows procedures of processing for switching the reverse assist mode from the off state to the on state. The processing shown in FIG. 3 is realized by the PU 92 repeatedly executing the reverse assist program 94a in predetermined cycles, for example. Note that in the following, the step number of each processing is expressed by a number preceded by “S”.

In the series of processing shown in FIG. 3, the PU 92 first acquires a steered angle α1 of the tractor 20 (S10). The steered angle α1 is calculated each time by the steering control device 70 using the rotational angle θm as an input. The PU 92 acquires the steered angle α1 calculated by the steering control device 70 each time. Also, the PU 92 acquires the hitch angle β (S12). The PU 92 then calculates a virtual steering angle α2 based on the steered angle α1 and the hitch angle β (S14). In the present embodiment, as an example, the virtual steering angle α2 is defined by an angle formed between a direction of travel of the ball joint 40 with respect to the front-rear direction of the trailer 30.

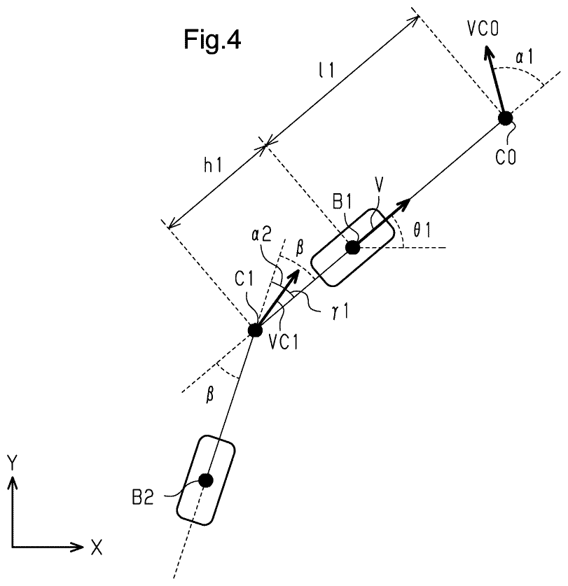

The reason for calculating the virtual steering angle α2 from the steered angle α1 and the hitch angle β will be described here with reference to FIG. 4. FIG. 4 illustrates a model of the articulated vehicle 10 that is used in the present embodiment. In the model illustrated in FIG. 4, a pair of the front wheels 22 of the tractor 20 is deemed to be a single front wheel C0, and also a pair of the rear wheels 24 of the tractor 20 is deemed to be a single rear wheel B1. That is to say, a two-wheel model is employed regarding the tractor 20. Also, a pair of the wheels 32 of the trailer 30 is deemed to be a single wheel B2. An angle formed between a line that is determined by the front wheel C0 and a hitch point C1, and a line determined by the hitch point C1 and the wheel B2, is the hitch angle β. The hitch point C1 corresponds to the axis 42 portion in FIG. 1. Also, a front wheel speed VC0, which is speed of the front wheel C0, is a vector of advance in a direction of the steered angle α1. The steered angle α1 is quantified as an angle formed between a direction in which the front wheel C0 advances and the line that is determined by the front wheel C0 and the hitch point C1. A direction of vehicle speed Vis parallel to the line determined by the front wheel C0 and the hitch point C1. Also, an angle formed between the direction of the vehicle speed V and an x direction in FIG. 4 is an angle θ1. Also, a distance l1 is a length between the front wheel C0 and the rear wheel B1. Also, a distance h1 is a length between the rear wheel B1 and the hitch point C1.

According to the above definitions, a direction of a speed VC1 of the hitch point C1 relative to a direction of travel from the wheel B2 to the hitch point C1 is the virtual steering angle α2. The virtual steering angle α2 is given by “−(β−γ1)”, using an angle γ1 of the direction of the speed VC1 of the hitch point C1 with respect to a direction of travel from the hitch point C1 to the front wheel C0.

In the model illustrated in FIG. 4, the following Expressions (c1) to (c3) hold when using coordinates (xc0, yc0) of the front wheel C0, coordinates (xb1, yb1) of the rear wheel B1, and coordinates (xc1, yc1) of the hitch point C1.

$$VC 0 \cdot cos α 1 = VB 1 \qquad ( c1 )$$

$$xc 0 = xb 1 + l 1 \cdot cos θ 1 \qquad ( c2 )$$

$$xc 1 = xb 1 - h 1 \cdot cos θ 1 \qquad ( c3 )$$

The following Expression (c4) is obtained using an expression obtained by differentiating both sides of the above Expressions (c2) and (c3), and the Expression (c1).

$$h 1 \cdot tan α 1 + l 1 \cdot tan γ 1 = 0 \qquad ( c4 )$$

According to the above Expression (c4), the angle γ1 can be expressed by the steered angle α1. Accordingly, the virtual steering angle α2 is expressed by the following Expression (c5).

$$α2 = - β - arctan \{ ( h 1 / l 1 ) \cdot tan ( α1 ) \} \qquad ( c5 )$$

That is to say, the virtual steering angle α2 can be found from the hitch angle β and the steered angle α1. Note that in the processing of S14, calculation of the virtual steering angle α2 using the above Expression (c5) is not essential. For example, the PU 92 may perform map computation of the virtual steering angle α2 in the processing of S14, by map data being stored in the storage device 94 in advance. The map data is data in which the hitch angle β and the steered angle α1 are input variables, and also the virtual steering angle α2 is an output variable.

Now, the map data is a data set of discrete values of the input variables and values of the output variable corresponding to each of the values of the input variables. Also, the map computation can be processing that, in a case in which the values of the input variables agree with any of the values of the input variables in the map data, takes a corresponding value of the output variable in the map data as a computation result. Also, the map computation can be processing that, in a case in which the values of the input variables do not agree with any of the values of the input variables in the map data, takes a value obtained by interpolating a plurality of values of the output variable that are included in the map data as a computation result. Also, alternatively, the map computation may be processing that, in a case in which the values of the input variables do not agree with any of the values of the input variables in the map data, takes the value of the output variable in the map data that corresponds to a closest value out of values of a plurality of the input variables included in the map data, as a calculation result.

Next, the PU 92 calculates a maximum virtual steering angle α2th (S16). The maximum virtual steering angle α2th is the lower limit of the magnitude of the virtual steering angle α2 at which a jackknife phenomenon occurs. That is to say, according to the model illustrated in FIG. 4, a first-order time differential value of the hitch angle β is expressed by the following Expression.

$$d β / dt = - ( V / l 2 ) \cdot sin β - \{ V / ( l 1 \cdot l 2 ) \} \cdot ( l 2 + h 1 \cdot cos β ) \cdot tan α \qquad ( c6 )$$

Now, in a case in which the jackknife phenomenon occurs, the hitch angle β cannot be changed, even by setting the steered angle α1 to a maximum value α1th. Accordingly, the hitch angle β, when the time differential value of the hitch angle β in the above Expression (c6) is set to zero and also the maximum value α1th is substituted into the steered angle α1, is deemed to be a jackknife hitch angle βth. Note however, that the steered angle α1 can take either positive or negative values, and accordingly both “α1th” and “(−1)·α1th” can be substituted into the above Expression (c6). Thus, the jackknife hitch angle βth actually takes two values. These two jackknife hitch angles βth are stored in advance in the storage device 94. The PU 92 then substitutes, to the jackknife hitch angle βth, the value of the two values that has a smaller absolute value of difference from the hitch angle β. The PU 92 then substitutes the jackknife hitch angle βth into the hitch angle β in the above Expression (c5), and also substitutes “α1th” or “(−1)·α1th” into the steered angle α1. Now, the sign of the steered angle α1 is made to agree with the sign of the actual steered angle α1. The virtual steering angle α2 that is calculated in this way is the maximum virtual steering angle α2th.

Next, the PU 92 determines whether or not a transient flag F1 is “1” (S18). In a case in which the transient flag F1 is “1”, this indicates that transitory processing is being executed after the reverse assist mode is switched from the off state to the on state. In a case in which the transient flag F1 is “0”, this indicates that the aforementioned transitory processing is not being executed. In a case in which determination is made that the transient flag F1 is “0” (S18: NO), the PU 92 determines whether or not the reverse assist mode has been switched from the off state to the on state (S20). In a case in which determination is made that the switching has been performed (S20: YES), the PU 92 vibrates the steering wheel 50 (S22). This processing is processing for notifying the driver that the steering wheel 50 has switched from being means for instructing steering of the tractor 20 to being means for instructing steering of the trailer 30. Note that the PU 92 substitutes “1” to the transient flag F1 in the processing of S22.

Next, the PU 92 determines whether or not the magnitude of the virtual steering angle α2 is no greater than the magnitude of the maximum virtual steering angle α2th (S24). In a case in which determination is made that this is no greater than the magnitude of the maximum virtual steering angle α2th (S24: YES), the PU 92 controls the steering angle θh so as to agree with a value in accordance with the virtual steering angle α2 (S26). On the other hand, in a case in which determination is made that the magnitude of the virtual steering angle α2 is greater than the magnitude of the maximum virtual steering angle α2th (S24: NO), the PU 92 controls the steering angle θh so as to agree with a value corresponding to the maximum virtual steering angle α2th (S28). Note that at this time, the PU 92 vibrates the steering wheel 50 when the steering angle θh matches the maximum virtual steering angle α2th.

On the other hand, in a case in which determination is made that the transient flag F1 is “1” (S18: YES), the PU 92 determines whether or not the steering angle θh agrees with the virtual steering angle α2 (maximum virtual steering angle α2th) (S30). More specifically, in a case in which the processing of S26 is being executed, the PU 92 determines whether or not the steering angle θh agrees with the virtual steering angle α2. On the other hand, in a case in which the processing of S28 is being executed, the PU 92 determines whether or not the steering angle θh agrees with the maximum virtual steering angle α2th. The processing of S30 is processing for determining whether or not the processing of S26 and S28 has been completed.

In a case in which determination is made that these do not agree (S30: NO), the PU 92 determines whether or not the magnitude of the steering torque Th is no smaller than a threshold value Tth (S32). This processing is processing for determining whether or not the driver has touched the steering wheel 50. That is to say, the driver operates the user interface 104 to switch the reverse assist mode from the off state to the on state. Accordingly, the driver is not touching the steering wheel 50 immediately after the reverse assist mode is switched from the off state to the on state. Although the processing of S26 and S28 is intended to be executed before the driver touches the steering wheel 50, in reality, there is a possibility that the driver may touch the steering wheel 50 while the processing of S26 and S28 is being executed.

In a case in which determination is made that a steering angle velocity ωh is no smaller than the threshold value Tth (S32: YES), the PU 92 reduces the magnitude of the steering angle velocity ωh (S34).

On the other hand, in a case in which determination is made that these agree (S30: YES), the PU 92 substitutes “0” to the transient flag F1 (S36: YES).

The PU 92 temporarily ends the series of processing shown in FIG. 3 in a case in which the processing of S26, S28, S34, and S36 is complete, or in a case in which a negative determination is made in the processing of S20 or S32.

### “Processing During Reverse Assist Mode”

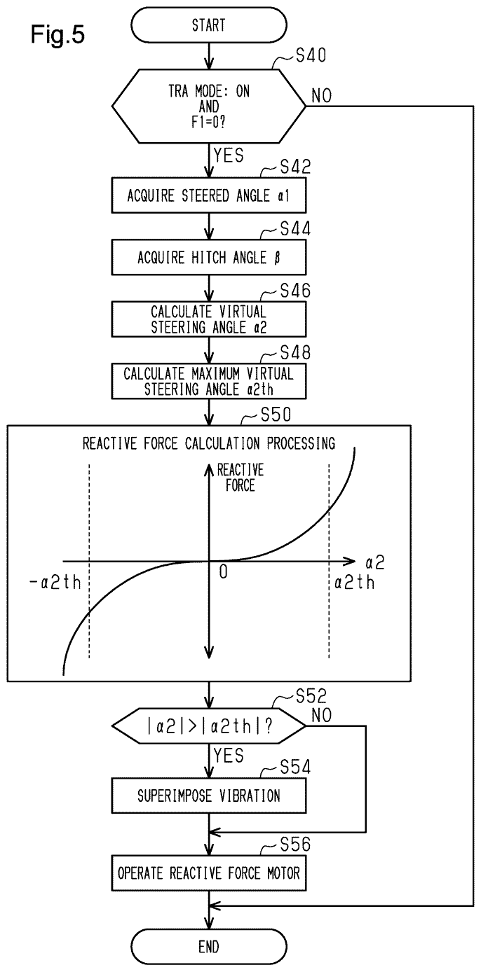

FIG. 5 describes processing in the reverse assist mode. The processing shown in FIG. 5 is realized by the PU 92 repeatedly executing the reverse assist program 94a in predetermined cycles, for example.

In the series of processing shown in FIG. 5, the PU 92 first determines whether or not a logical product of the following condition (A) and condition (B) is true (S40).

Condition (A): This is a condition to the effect that the reverse assist mode is in the on state.

Condition (B): This is a condition to the effect that the transient flag F1 is “0”.

In a case in which determination is made that the logical product is true (S40: YES), the PU 92 executes the same processing as the processing in S10 to S16 (S42 to S48).

Next, the PU 92 takes the virtual steering angle α2 as input, and calculates a reactive force to be applied to the steering wheel 50 (S50). The PU 92 sets the magnitude of the reactive force in a case in which the magnitude of the virtual steering angle α2 is great to be no smaller than the magnitude of the reactive force in a case in which the magnitude of the virtual steering angle α2 is small. In particular, the PU 92 makes an amount of increase in magnitude of the reactive force with respect to amount per unit increase in the magnitude of the virtual steering angle α2 to be greater in a case in which the magnitude of the virtual steering angle α2 is no smaller than the maximum virtual steering angle α2th, as compared to a case of being smaller than that of the maximum virtual steering angle α2th. This is a setting for suppressing the magnitude of the steering angle θh from being further displaced beyond the magnitude of the maximum virtual steering angle α2th.

Note that in the statement “A is taken as input, and B when A is great is made to be no smaller than B when A is small”, the case in which A is great and the case in which A is small refer to the relative relation in magnitude when comparing the two. For example, “a case in which A is great” corresponds to a case in which “Ais a first value”, and “a case in which A is small” corresponds to “a case in which A is a second value that is smaller than the first value”. This also means that, according to the above description, depending on the settings of the first value and the second value, B in a case in which A is the first value may be greater than B in a case in which A is the second value.

The processing of S50 may be, for example, processing in which the PU 92 performs map computation of the reactive force in a state in which map data is stored in the storage device 94. The map data here is data in which the virtual steering angle α2 is an input variable and also the reactive force is an output variable.

Next, the PU 92 determines whether or not the magnitude of the virtual steering angle α2 is greater than the magnitude of the maximum virtual steering angle α2th (S52). In a case in which determination is made that this is greater than the magnitude of the maximum virtual steering angle α2th (S52: YES), the PU 92 superimposes a component that vibrates the steering wheel 50 upon the reactive force (S54). This processing is for notifying the driver that a turning radius of the trailer 30 cannot be made any smaller.

The PU 52 then operates the reactive force motor 52 in accordance with the reactive force that is calculated in the processing of S50 (S56). At this time, in a case in which the processing of S54 has been performed, the PU 52 superimposes a vibration component on the torque of the reactive force motor 52.

Note that the PU 92 ends the series of processing shown in FIG. 5 for the time being, in a case in which the processing of S56 is completed, or in a case in which a negative determination is made in the processing of S40.

### “Transitioning to Off State of Reverse Assist Mode”

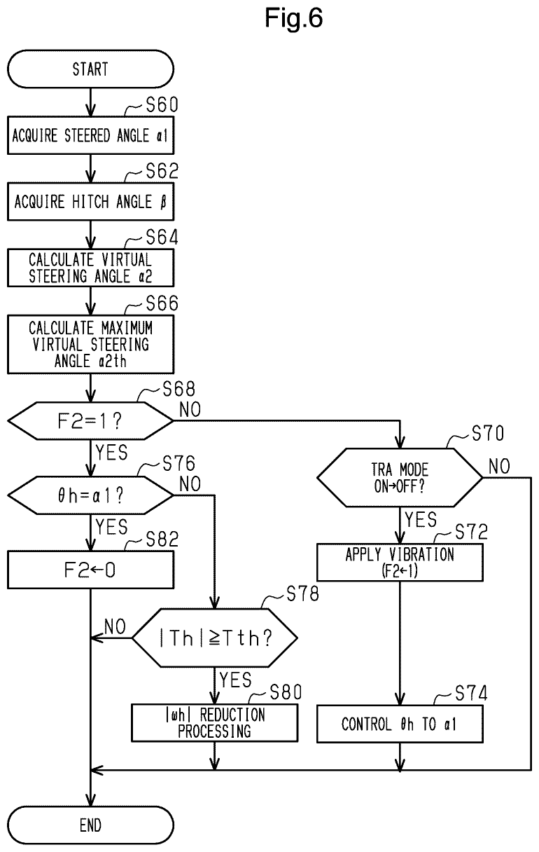

FIG. 6 shows procedures of processing relating to switching the reverse assist mode from the on state to the off state. The processing shown in FIG. 6 is realized by the PU 92 repeatedly executing the reverse assist program 94a in predetermined cycles, for example.

In the series of processing shown in FIG. 6, the PU 92 first executes processing that is the same as the processing in S10 to S16 (S60 to S66). Next, the PU 92 determines whether or not a transient flag F2 is “1” (S68). In a case in which the transient flag F2 is “1”, this indicates that transitory processing is being executed after the reverse assist mode is switched from the on state to the off state. In a case in which the transient flag F2 is “0”, this indicates that the aforementioned transitory processing is not being executed. In a case in which determination is made that the transient flag F2 is “0” (S68: NO), the PU 92 determines whether or not the reverse assist mode has been switched from the on state to the off state (S70).

In a case in which determination is made that the switching has been performed (S70: YES), the PU 92 vibrates the steering wheel 50 (S72). This processing is processing for notifying the driver that the steering wheel 50 has switched from being means for instructing steering of the trailer 30 to being means for instructing steering of the tractor 20. Note that the PU 92 substitutes “1” to the transient flag F2 in the processing of S72. Next, the PU 92 operates the reactive force motor 52 to displace the steering wheel 50 such that the steering angle θh agrees with a value corresponding to the steered angle α1 (S74).

On the other hand, in a case in which determination is made that the transient flag F2 is “1” (S68: YES), determination is made regarding whether or not the steering angle θh agrees with the steered angle α1 (S76). In a case in which determination is made that these do not agree (S76: NO), the PU 92 determines whether or not the magnitude of the steering torque Th is no smaller than the threshold value Tth (S78). This processing is processing for determining whether or not the driver has touched the steering wheel 50. That is to say, the driver operates the user interface 104 to switch the reverse assist mode from the on state to the off state. Accordingly, the driver is not touching the steering wheel 50 immediately after the reverse assist mode is switched from the off state to the on state. Although the processing of S74 is intended to be executed before the driver touches the steering wheel 50, in reality, there is a possibility that the driver may touch the steering wheel 50 while the processing of S74 is being executed.

In a case in which determination is made that this is no smaller than the threshold value Tth (S78: YES), the PU 92 reduces the magnitude of the steering angle velocity ωh (S80). On the other hand, in a case in which determination is made that these agree (S76: YES), the PU 92 substitutes “0” to the transient flag F2 (S82: YES).

Note that the PU 92 temporarily ends the series of processing shown in FIG. 6 in a case in which the processing of S74, S80, and S82 is complete, or in a case in which a negative determination is made in the processing of S70 or S78.

### “Steering Processing”

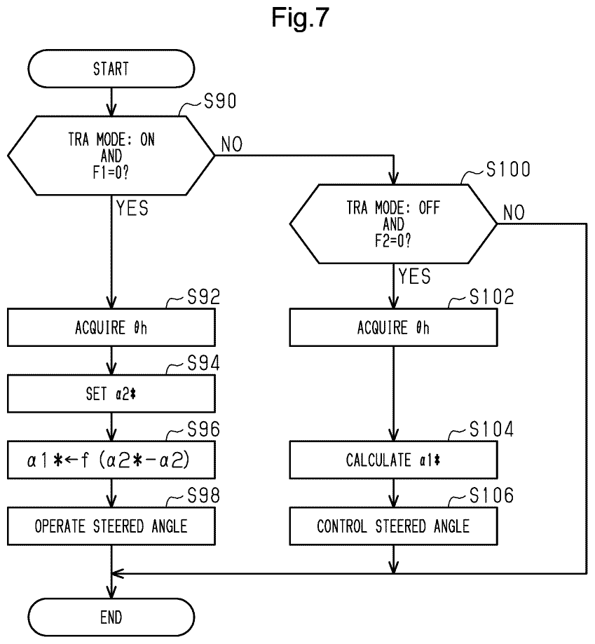

FIG. 7 describes steering processing. The series of processing shown in FIG. 7 is realized by the PU 92 repeatedly executing the reverse assist program 94a in predetermined cycles, for example.

In the series of processing shown in FIG. 7, the PU 92 first determines whether or not the logical product of the above-described condition (A) and condition (B) is true (S90). In a case in which determination is made that the logical product is true (S90: YES), the PU 92 acquires the steering angle θh (S92). The PU 92 then substitutes a value obtained by performing a predetermined conversion on the steering angle θh into a target virtual steering angle α2* (S94). Next, the PU 92 calculates the target steered angle α1*, which is a manipulated variable of feedback control, with the virtual steering angle α2 as a controlled variable and also the target virtual steering angle α2* as a target value of the controlled variable (S96). The PU 92 then operates the steering motor 62 such that the steered angle α1 becomes the target steered angle α1* (S98).

On the other hand, in a case in which determination is made that the above logical product is false (S90: NO), the PU 92 determines whether or not the logical product of the following condition (C) and condition (D) is true (S100).

Condition (C): This is a condition to the effect that the reverse assist mode is in the off state.

Condition (D): This is a condition to the effect that the transient flag F2 is “0”.

In a case in which determination is made that the logical product of the condition (C) and the condition (D) is true (S100: YES), the PU 92 acquires the steering angle θh (S102). Next, the PU 92 sets the target steered angle α1* in accordance with the steering angle θh (S104). The PU 92 then executes control with the steered angle α1 as a controlled variable, and the target steered angle α1* as a target value of the controlled variable (S106).

Note that the PU 92 ends the series of processing shown in FIG. 7 in a case in which the processing of S98 and S106 is complete, or in a case in which negative determination is made in the processing of S100.

### Functions and Effects of Present Embodiment

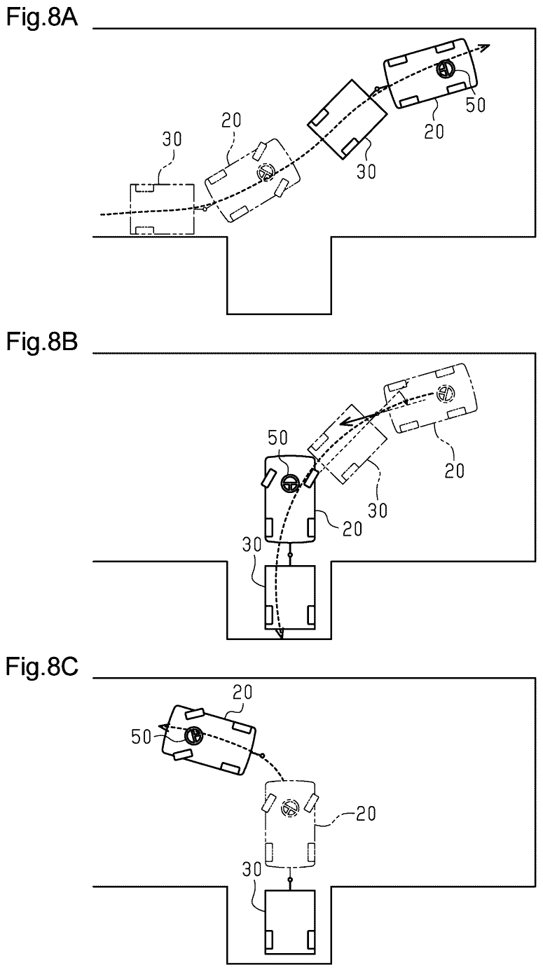

FIG. 8A to FIG. 8C illustrate an example of using of the reverse assist mode.

FIG. 8A illustrates an example in which the articulated vehicle 10 is advanced to a reverse start position. During this period, the tractor 20 is steered by operating the steering wheel 50. FIG. 8B illustrates an example in which the articulated vehicle 10 is made to travel in reverse using the reverse assist mode. During this period, the target virtual steering angle α2* is determined by operations of the steering wheel 50.

FIG. 8C illustrates an example in which the tractor 20 is detached from the trailer 30, and the tractor 20 travels alone. That is to say, in a case in which the reverse assist mode is in the off state, the PU 92 sets the steering angle θh as a variable indicating an instruction for steering the tractor 20. The PU 92 then controls the steered angle α1 in accordance with the steering angle θh. On the other hand, in a case of a state in which the reverse assist mode is on, the PU 92 sets the steering angle θh as a variable indicating an instruction for steering the trailer 30. The PU 92 then controls the virtual steering angle α2 in accordance with the steering angle θh.

In this way, the instruction input means regrading steering of the tractor 20 and instruction input means regarding steering of the trailer 30 are the same hardware that is the steering wheel 50. This eliminates any need to add dedicated input means for instructing steering of the trailer 30.

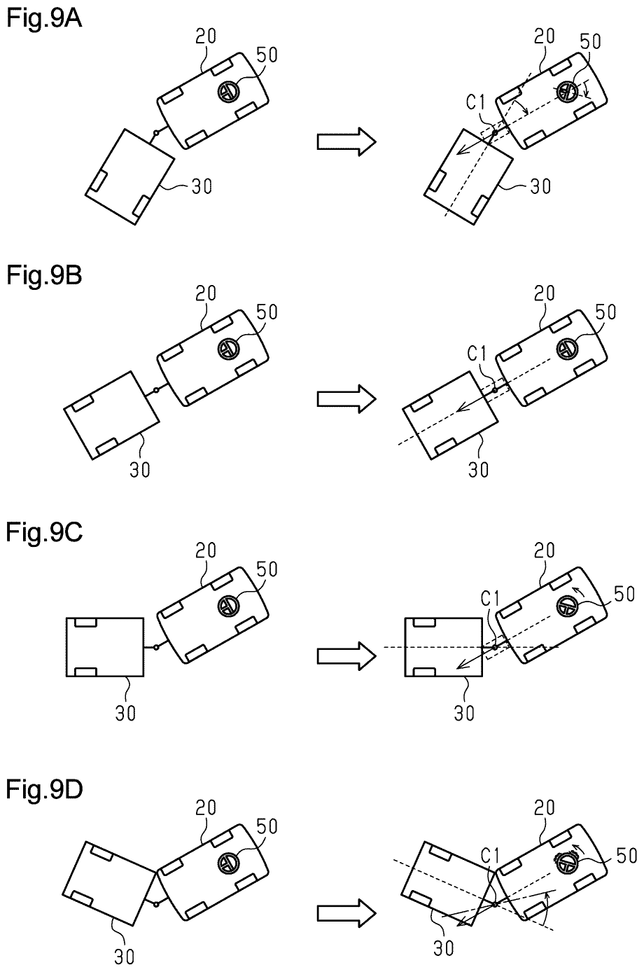

FIG. 9A to FIG. 9D illustrate examples in which the reverse assist mode is switched from the off state to the on state. FIG. 9A illustrates a state in which the steering wheel 50 is in a neutral position in a state in which the reverse assist mode is off. Accordingly, the front wheels 22 that serve as the steered wheels of the tractor 20 are in a straight-ahead state. Also illustrated is an example in which the trailer 30 faces rightward in the state in which the reverse assist mode is off. Accordingly, the virtual steering angle α2 does not correspond to the straight-ahead state. In this state, when the reverse assist mode is switched to the on state, the PU 92 turns the steering wheel 50 to the right direction. Thus, the steering angle θh is displaced so as to match the virtual steering angle α2, which is the traveling direction of the hitch point C1.

FIG. 9B illustrates a state in which the steering wheel 50 is in the neutral position, in the state in which the reverse assist mode is off. In this example, the traveling direction of the hitch point C1 is also a straight-ahead direction. Accordingly, even when the reverse assist mode is switched to the on state, the PU 92 does not cause displacement of the steering wheel 50.

FIG. 9C illustrates a state in which the steering wheel 50 is in the neutral position, in the state in which the reverse assist mode is off. Accordingly, the front wheels 22 that serve as the steered wheels of the tractor 20 are in a straight-ahead state. Also illustrated is a case in which the trailer 30 faces leftward in the state in which the reverse assist mode is off. Accordingly, the virtual steering angle α2 does not correspond to the straight-ahead state. In this state, when the reverse assist mode is switched to the on state, the PU 92 turns the steering wheel 50 to the left direction. Thus, the steering angle θh is displaced so as to match the virtual steering angle α2, which is the traveling direction of the hitch point C1.

In this way, according to the present embodiment, the state of the steering wheel 50 can be matched with the state of the trailer 30, without displacing the front wheels 22 serving as the steered wheels, in conjunction with the reverse assist mode being switched to the on state.

FIG. 9D illustrates an example in which the hitch angle β is excessively great in the state in which the reverse assist mode is off, and the jackknife phenomenon is occurring. In this case, when the reverse assist mode is switched to the on state, the PU 92 matches the steering angle θh to the maximum virtual steering angle α2th. The PU 92 then vibrates the steering wheel 50.

Thus, in the present embodiment, the steering wheel 50 is changed to a position where the state of the trailer 30 matches a state that corresponds to a boundary of an allowable range. This allows the driver to appropriately comprehend the state relating to steering of the trailer 30.

The present embodiment further has the following functions and effects.
(1) In a case in which the state of the trailer 30 falls outside of the allowable range during execution of the processing in S92 to S98, the PU 92 makes notification to that effect. In this way, in a case in which the driver is inputting intent to steer the trailer 30, but that intent is an instruction that cannot be realized in reality, the driver can be notified to that effect.
(2) In a state in which the reverse assist mode is on, the PU 82 applied a reactive force countering the operation of the steering wheel 50 in response to the state of the steering wheel 50 being operated. In particular, the PU 92 performs control such that the reactive force, in a case of a state of steering in which the turning radius of the trailer 30 is small, is no smaller than the reactive force in a case of a state of steering in which the turning radius of the trailer 30 is great. This allows the driver to be imparted a steering sensation similar to that of steering a normal vehicle, in a case of steering the trailer 30.
(3) The PU 92 makes an amount of increase in magnitude of the reactive force with respect to amount per unit increase in the magnitude of the virtual steering angle α2 to be greater in a case in which the magnitude of the virtual steering angle α2 is no smaller than the maximum virtual steering angle α2th as compared to in a case of being smaller than the maximum virtual steering angle α2th. This enables a situation, in which the state of the steering wheel 50 reaches a state that corresponds to a state exceeding the allowable range of the trailer 30, to be suppressed.
(4) In a case of switching from the reverse assist mode on state to the reverse assist mode off state, the PU 92 displaces the state of the steering wheel 50 so as to match the steered angle of the front wheels 22 serving as the steered wheels. This enables the state of the steering wheel 50 to match the state of the steered wheels, without displacing the steered wheels in conjunction with switching to the off state.
(5) In a case in which the driver touches the steering wheel 50 while the processing of displacing the steering wheel 50 to achieve the above-described matching is being executed, the PU 82 reduces the displacement speed of the steering wheel 50. This can suppress the driver from being imparted with an impression of behavior that is significantly contrary to his/her intent.
(6) Prior to executing the processing of displacing the steering wheel 50 so as to achieve the above-described matching, the PU 92 performs notification to that effect. This enables the driver to readily comprehend that, what can be instructed by input operation of the steering wheel 50, has been switched.
(7) The PU 82 sets the target virtual steering angle α* in response to an input operation that is performed on the steering wheel 50. This allows the driver to give instructions regarding the direction of travel of the linking point of the trailer 30 and the tractor 20 by input operation of the steering wheel 50.

### OTHER EMBODIMENTS

Note that the present embodiment can be carried out modified as follows. The present embodiment and the following modifications can be carried out combined with each other insofar as no technical contradictions arise.

### “Regarding Target Virtual Steering Angle Setting Processing”

The target virtual steering angle α2* being a value obtained by performing predetermined conversion on the steering angle θh is not essential. For example, target virtual steering angle setting processing may be processing of substituting the steering angle θh into the target virtual steering angle α2*.

### “Regarding Trailer Steering Processing”

Trailer steering processing is not limited to processing of executing feedback control in which the virtual steering angle α2 is used as a controlled variable and also the target virtual steering angle α2* is used as a target value for the controlled variable. The trailer steering processing may be, for example, processing of executing open-loop control with the virtual steering angle α2 as the controlled variable.
The trailer steering processing being processing in which the virtual steering angle α2 is the controlled variable, is not essential. The trailer steering processing may be, for example, processing in which the radius of curvature of the traveling path of the trailer 30 is used as the controlled variable. Also, the trailer steering processing may be, for example, processing in which the traveling path of the trailer 30 itself is used as the controlled variable.

### “Regarding Deviation Notification Processing”

In a case in which the magnitude of the virtual steering angle α2 exceeds that of the maximum virtual steering angle α2th, the processing of making notification to this effect is not limited to the processing of applying vibration to the steering wheel 50. The above processing of making notification to this effect may be, for example, processing of changing a color that is displayed on the display device. The display device here may be a device that displays a rearward image from the tractor 20. The display device may also be a device that is provided on the steering wheel 50 and that conveys messages by colors.
The PU 92 may execute the deviation notification processing on the condition that the transient flag F1 is “0”. That is to say, for example, the PU 92 does not have to perform execution when the processing of S28 is completed.

### “Regarding Reactive Force Application Processing”

Reactive force application processing is not limited to the processing of variably setting the magnitude of the reactive force in accordance with the magnitude of the virtual steering angle α2 before the magnitude of the virtual steering angle α2 reaches the magnitude of the maximum virtual steering angle α2th. The reactive force application processing may be processing in which the reactive force is kept constant until the magnitude of the virtual steering angle α2 reaches the magnitude of the maximum virtual steering angle α2th, for example.

### “Regarding Matching Processing”

The processing of changing the steering angle θh such that the steering angle θh and the virtual steering angle α2 match, in conjunction with switching the reverse assist mode from the off state to the on state, is not essential. For example, the PU 92 may execute processing of changing the virtual steering angle α2 such that the steering angle θh and the virtual steering angle α2 match, in conjunction with switching the reverse assist mode from the off state to the on state. Note that the matching processing for matching the steering angle θh and the virtual steering angle α2, in conjunction with switching the reverse assist mode from the off state to the on state, is not essential.
The processing of changing the steering angle θh such that the steering angle θh and the steered angle α1 match, in conjunction with switching the reverse assist mode from the on state to the off state, is not essential. For example, the PU 92 may execute processing of changing the steered angle α1 such that the steering angle θh and the steered angle α1 match, in conjunction with switching the reverse assist mode from the on state to the off state. Note that the matching processing for matching the steering angle θh and the steered angle α1, in conjunction with switching the reverse assist mode from the on state to the off state, is not essential.

### “Regarding Switching Notification Processing”

The processing of making notification of switching, in conjunction with switching the reverse assist mode from the off state to the on state, is not limited to the processing of applying vibration to the steering wheel 50. In other words, the processing of making notification to the effect that the state has transitioned from the state in which the steered angle α1 can be adjusted, to the state in which the virtual steering angle α2 can be adjusted, by operating the steering wheel 50, is not limited to the processing of applying vibration to the steering wheel 50. For example, the processing of making notification to the effect of the above transitioning may be processing of changing a color displayed on the display device. The display device here may be a device that displays a rearward image from the tractor 20. The display device may also be a device that is provided on the steering wheel 50 and that conveys messages by colors.
The processing of making notification of switching in conjunction with switching the reverse assist mode from the on state to the off state is not limited to the processing of applying vibration to the steering wheel 50. In other words, the processing of making notification to the effect that the state has transitioned from the state in which the virtual steering angle α2 can be adjusted, to the state in which the steered angle α1 can be adjusted, by operating the steering wheel 50, is not limited to the processing of applying vibration to the steering wheel 50. For example, the processing of making notification to the effect of the above transitioning may be processing of changing a color displayed on the display device. The display device here may be a device that displays a rearward image from the tractor 20. The display device may also be a device that is provided on the steering wheel 50 and that conveys messages by colors.

### “Regarding Reduction Processing”

Executing the processing of S34 is not essential. For example, in a case in which the steering wheel 50 is operated while the steering angle θh is being changed such that the steering angle θh and the virtual steering angle α2 match, in conjunction with switching the reverse assist mode from the off state to the on state, the following may be performed. That is to say, the processing of changing the steering angle θh so as to match the virtual steering angle α2 may be stopped. In this case, the steered angle α1 may be operated in order to control the virtual steering angle α2 in response to the operation of the steering wheel 50.
Executing the processing of S80 is not essential. For example, in a case in which the steering wheel 50 is operated while the steering angle θh is being changed such that the steering angle θh and the steered angle α1 match, in conjunction with switching the reverse assist mode from the on state to the off state, the following may be performed. That is to say, the processing of changing the steering angle θh so as to match the steered angle α1 may be stopped. In this case, the steered angle α1 may be controlled in response to the operation of the steering wheel 50.
   “Regarding Entity of Processing when Reverse Assist Mode is in Off State”
In the above embodiment, matching processing in the off state of the reverse assist mode was the processing in which the ADAS ECU 90 transmits a command signal to the steering control device 70, but this is not restrictive. For example, the matching processing when the reverse assist mode is in the off state may be executed by the steering control device 70 independently of instructions from the ADAS ECU 90.

### “Regarding Input Unit”

The input unit for inputting the intent to steer the tractor 20 or the trailer 30 is not limited to the steering wheel 50. For example, this may be a joystick.

### “Regarding Steering System”

For example, a clutch may be provided to switch between a transmitting state and an interrupted state, with regard to power, between the steering wheel 50 and the front wheels 22. In this case, in a case in which the reverse assist mode is in the off state, the clutch may be in an engaged state. In other words, tractor steering processing may be executed with the clutch in the engaged state.

### “Regarding Control Device”

The ADAS ECU 90 and the steering control device 70 may be configured integrally.
The control device is not limited to an arrangement that includes the PU 92 and the storage device 94, and that executes software processing. For example, the control device may include a dedicated hardware circuit, such as, for example, an ASIC or the like, that performs, by hardware processing, at least part of the various types of processing executed in the above embodiment. That is to say, the control device can have any one of the following configurations (a) to (c). (a) A processing circuit including a processing device that executes all of the above processing according to a program, and a program storage device such as a storage device or the like that stores the program. (b) A processing circuit including a processing device that executes part of the above processing according to a program, a program storage device, and a dedicated hardware circuit that executes the remainder of the processing. (c) A processing circuit including a dedicated hardware circuit that executes all of the above processing. There may be a plurality of software execution devices that include a processing device and a program storage device, and a plurality of dedicated hardware circuits.

### “Regarding Computer”

A computer that executes a control program such as the reverse assist program 94a or the like is not limited to being a computer that is installed in the articulated vehicle 10. For example, this computer may be made up of the both of the PU 52 installed in the articulated vehicle 10 and a mobile terminal of the driver. In this case, the mobile terminal may execute the processing of S16, for example.

### “Regarding Vehicle”

The articulated vehicle is not limited to the vehicle illustrated in FIG. 1.

1. A control device for an articulated vehicle including a tractor and a trailer that is towed by the tractor, wherein:
the tractor includes an input unit and steered wheels;
the control device is configured to execute switching determination processing, tractor steering processing, and trailer steering processing;
the switching determination processing is processing of determining whether a reverse assist mode is in an on state or an off state;
the tractor steering processing is processing of steering the tractor in response to an input operation to the input unit in a case in which the reverse assist mode is in the off state; and
the trailer steering processing is processing of operating a steered angle of the steered wheels in order to steer the trailer in response to an input operation to the input unit in a case in which the reverse assist mode is in the on state, in a state in which power transmission between the input unit and the steered wheels is interrupted.

2. The control device for the articulated vehicle according to claim 1, wherein:
the control device is configured to execute matching processing; and
the matching processing includes processing of, in a case in which the reverse assist mode is switched from the off state to the on state, displacing a state of the input unit so as to match a state of the trailer in a case in which the articulated vehicle travels.

3. The control device for the articulated vehicle according to claim 2, wherein the matching processing includes processing of, in a case in which the state of the trailer falls outside of an allowable range, displacing the input unit to a position that matches a state corresponding to a boundary of the allowable range.

4. The control device for the articulated vehicle according to claim 1, wherein:
the control device is configured to execute deviation notification processing; and
the deviation notification processing includes processing of, in a case in which a state of the trailer deviates from an allowable range during execution of the trailer steering processing, performing notification to that effect.

5. The control device for the articulated vehicle according to claim 1, wherein:
the control device is configured to execute reactive force application processing; and
the reactive force application processing includes processing for applying reactive force that counters operation of the input unit in response to an operation state of the input unit in an on state of the reverse assist mode, and also processing for making the reactive force, in a case of a steering state in which a turning radius of the trailer is small, to be no smaller than the reactive force in a case of the steering state in which the turning radius of the trailer is great.

6. The control device for the articulated vehicle according to claim 5, wherein the reactive force application processing includes processing of increasing an amount of increase in a magnitude of the reactive force relative to an amount per unit of displacement of the input unit, the closer a state of the trailer is to a boundary of an allowable range.

7. The control device for the articulated vehicle according to claim 1, wherein:
the control device is configured to execute matching processing; and
the matching processing includes processing of, in a case in which the reverse assist mode is switched from the on state to the off state, displacing a state of the input unit so as to match the steered angle of the steered wheels.

8. The control device for the articulated vehicle according to claim 2, wherein:
the control device is configured to execute reduction processing; and
the reduction processing includes processing of, in a case in which a driver touches the input unit while the matching processing is being executed, reducing a displacement speed of the input unit.

9. The control device for the articulated vehicle according to claim 2, wherein:
the control device is configured to execute switching notification processing; and
the switching notification processing includes processing of, prior to displacement of the input unit due to the matching processing, performing notification to that effect.

10. The control device for the articulated vehicle according to claim 1, wherein:
the trailer steering processing includes target virtual steering angle setting processing and virtual steering angle control processing;
the target virtual steering angle setting processing is processing of setting a target virtual steering angle in response to the input operation to the input unit;
the target virtual steering angle is a target value of a virtual steering angle;
the virtual steering angle is a variable indicating a direction of travel at a linking point of the trailer and the tractor; and
the virtual steering angle control processing is processing for operating the steered angle of the steered wheels by a manipulated variable of control in which the virtual steering angle is used as a controlled variable and the target virtual steering angle is used as a target value of the controlled variable.

11. The control device for the articulated vehicle according to claim 1, wherein the input unit is a steering wheel.

12. A control method for an articulated vehicle including a tractor and a trailer that is towed by the tractor, wherein:
the tractor includes an input unit and steered wheels;
the control method includes a step of executing switching determination processing, tractor steering processing, and trailer steering processing;
the switching determination processing is processing of determining whether a reverse assist mode is in an on state or an off state;
the tractor steering processing is processing of steering the tractor in response to an input operation to the input unit in a case in which the reverse assist mode is in the off state; and
the trailer steering processing is processing of operating a steered angle of the steered wheels in order to steer the trailer in response to an input operation to the input unit in a case in which the reverse assist mode is in the on state, in a state in which power transmission between the input unit and the steered wheels is interrupted.

13. A non-transitory computer-readable medium storing a control program for an articulated vehicle including a tractor and a trailer that is towed by the tractor, wherein:
the tractor includes an input unit and steered wheels;
the control program is configured to cause a computer to execute switching determination processing, tractor steering processing, and trailer steering processing;
the switching determination processing is processing of determining whether a reverse assist mode is in an on state or an off state;
the tractor steering processing is processing of steering the tractor in response to an input operation to the input unit in a case in which the reverse assist mode is in the off state; and
the trailer steering processing is processing of operating a steered angle of the steered wheels in order to steer the trailer in response to an input operation to the input unit in a case in which the reverse assist mode is in the on state, in a state in which power transmission between the input unit and the steered wheels is interrupted.
